(19) United States
(12) Patent Application Publication
(10) Pub. No.: US 2014/0041032 A1
(43) Pub. Date: Feb. 6, 2014

(54) System and Method for Detecting Network Intrusions Using Statistical Models and a Generalized Likelihood Ratio Test

(71) Applicant: Opera Solutions, LLC, Jersey City, NJ (US)

(72) Inventors: Christopher Scheper, San Diego, CA (US); William J. Roberts, Rockville, MD (US)

(73) Assignee: Opera Solutions, LLC, Jersey City, NJ (US)

(21) Appl. No.: 13/956,720

(22) Filed: Aug. 1, 2013

Related U.S. Application Data
(60) Provisional application No. 61/678,298, filed on Aug. 1, 2012.

(51) Int. Cl. H04L 29/06

(52) U.S. Cl. CPC H04L 63/14
USPC 726/23

(57) ABSTRACT

A system and method for detecting network intrusions using one or more statistical models and a generalized likelihood ratio test (GLRT) is provided. The system includes a computer system and a network intrusion detection engine executed by the computer system. To detect network intrusions, the system receives network traffic data, computes a likelihood using one or more statistical models, such as an Markov-modulated Poisson process, and processes the traffic data using a GLRT. The statistical models are used to assess the likelihood of seeing a particular pattern of network traffic. The GLRT is used to classify a particular pattern as either indicative of an attack or not indicative of an attack. The system could apply one or more types of statistical models, such as in a flexible multi-tiered approach.

### CROSS-REFERENCE TO RELATED APPLICATION

This application claims priority to U.S. Provisional Patent Application No. 61/678,298 filed on Aug. 1, 2012, which is incorporated herein by reference in its entirety and made a part hereof.

### BACKGROUND OF THE INVENTION

1. Field of the Invention

The present invention relates generally to a system for detecting network intrusions. More specifically, the present invention relates to a system and method for network traffic anomaly detection using one or more statistical models and a generalized likelihood ratio test.

2. Related Art

Anomaly detection is a known process for searching for patterns in data that do not conform to expected behavior. Such detection often results in actionable and important information. Anomaly detection occurs in a vast number of applications, such as medical imaging, credit card fraud detection, sensor networks (e.g., aircraft avionics systems), etc.

Anomaly detection is a particularly important aspect of computer network security (cybersecurity). Intrusion detection systems of cybersecurity systems often utilize anomaly detection to identify when a computer network has been compromised. Anomalies in network traffic can indicate that a network is under attack. For instance, anomalous traffic signals on a computer network can indicate that a computer on the network is infected and possibly divulging secure or private information.

There are many challenges associated with anomaly detection, including defining a normal/background region that encompasses all normal behavior, imprecision in the difference between normal and anomalous behavior, difficulty in detecting future anomalous behavior due to the evolving definition of normal behavior (e.g., typical Internet behavior), and limited availability of labeled (e.g., normal and anomaly) data for use in model training, which is particularly true for network anomaly detection. Often, solutions to these challenges rely on making assumptions about the form of the data, the form of an anomaly, or both.

It is known that network traffic can be processed using statistical models, such as the Markov-modulated Poisson process (MMPP), which is a process having a set of underlying states that change according to a continuous Markov chain. Further, the generalized likelihood ratio test (GLRT) is a statistical test for deciding between two hypotheses and has been widely used in signal classification problems. Both the MMPP and GLRT have been individually used in anomaly detection.

### SUMMARY OF THE INVENTION

The present invention relates to a system and method for detecting network intrusions using one or more statistical models and a GLRT. The system includes a computer system and a network intrusion detection engine. To detect network intrusions, the system receives network traffic data, computes a likelihood using one or more statistical models, such as an MMPP, and processes the traffic data using a GLRT. The statistical models are used to assess the likelihood of seeing a particular pattern of network traffic. The GLRT is used to classify a particular pattern as either indicative of an attack or not indicative of an attack. The system could apply one or more types of statistical models, such as in a flexible multi-tiered approach.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart showing overall processing steps carried out by the intrusion detection system;

FIG. 2 shows overall processing steps according to the system for processing network traffic using a Markov-modulated Poisson process;

FIG. 3 shows sample empirical receiver operator characteristic curves of various statistical models; and

FIG. 4 is a diagram showing hardware and software components of the system of the present invention.

### DETAILED DESCRIPTION OF THE INVENTION

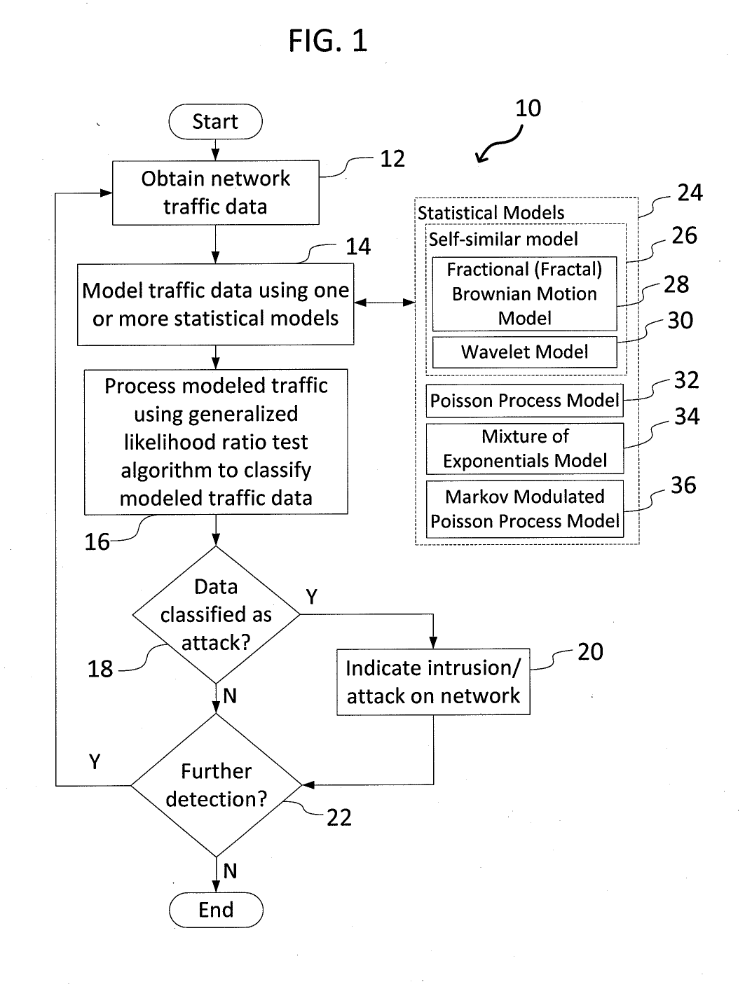

The present invention relates to a system and method for detecting network intrusions using one or more statistical models and a GLRT, as discussed in detail below in connection with FIGS. 1-4.

FIG. 1 is a flowchart showing overall processing steps 10 carried out by the network intrusion detection system of the present invention. The network intrusion detection system operates on the basic assumption that the normal behavior of a computer system occurs at high probability regions of a stochastic model, and anomalous behavior occurs at low probability regions. Beginning in step 12, the system electronically obtains (receives) network traffic data (e.g., network traffic signals). The traffic data could be received periodically by the system, and/or monitored in real time. In step 14, using statistical techniques (e.g., an expectation-maximization algorithm), one or more statistical models 24 executed by the system processes traffic data, where such models 24 could include a self-similar model 26 (e.g., Fractal Brownian Motion model 28 and Wavelet model 30), Poisson process model 32, Mixture of Exponentials model 34, and/or MMPP model 36.

In step 16, the GLRT is applied to process and classify the traffic data, as discussed in more detail below, and in step 18, the data is classified as either an attack or not an attack. If the data is classified as an attack, the intrusion/attack is indicated to the user in step 20. In step 22, a determination is made as to whether further detection is desired. If so, the process reverts back to step 12.

An important concept in using statistical models 24 to process Internet traffic is long-range dependence (LRD), which refers to the correlation structure of a time series (i.e., the correlation of the time series x(t) with the same time series with a lag τ, x(t−τ)). If the correlation decreases exponentially as τ→∞, the time series is said to exhibit short-range dependence (SRD), otherwise, it exhibits LRD. Generally speaking, the models for Internet traffic that exhibit LRD do not always faithfully replicate second-order statistics, such as variance. Additionally, some SRD models are able to replicate LRD behavior over several orders of magnitude, while the exponential tail becomes dominant far beyond the time interval of interest. Therefore, SRD models may faithfully replicate Internet traffic on time scales appropriate for anomaly detection.

One statistical model that could be used with the present invention is a self-similar model 26. A self-similar model 26 has the same correlation structure over different timescales and exhibits LRD. A Fractional Brownian motion model 28 is an example of a self-similar traffic model 26 which captures the LRD of Internet traffic. Additionally, a Wavelet model 30 can be used to describe the stochastic properties of Internet traffic. Wavelet models 30 can be used to efficiently generate self-similar traffic.

Another type of model that could be used is a Poisson process model 32, which is the simplest model of Internet traffic. Because the process generates events (e.g., packet arrivals) at a constant rate on average, Poisson process models 32 can be characterized by the average time between events. Generalizations of the Poisson process have been quite successful in traffic models. For instance, an ON-OFF source model, where a Poisson process with a rate λ is turned on and off with a certain frequency, has been used to model voice traffic (where ON=speech), and such a model could be adapted for implementation as the model 32.

An additional type of model that could be used is a Mixture of Exponentials model 34. This model is a process whose events are generated by one of k exponential distributions with mean λᵢ, where the exponential distribution is chosen with probability pᵢ. Therefore, the distribution is given by:

$$f ( x ) = {\sum }_{i = 1}^{k} {p}_{i} {λ}_{i} e \text{?} \\ \text{?} \text{indicates text missing or illegible when filed} \qquad Equation 1$$

This distribution, also called a hyperexponential distribution, is often used to model ON-OFF processes where both the ON and OFF states have exponential distributions. The performance of burst switching models is greatly improved when silent and talkburst phases are considered hyperexponential. The hyperexponential distribution has a coefficient of variation that is greater than one and is often used in place of other heavy tailed distributions because it is analytically tractable. A recursive algorithm can be used to fit the model 34 to distributions with heavy tails. Additionally, a two-component Mixture of Exponentials model 34 has three parameters, and can be fit to have any mean and variance.

The present invention can also utilize an MMPP model 36 to process network traffic. The MMPP 36 has become well established as a model for Internet traffic, because it faithfully models key properties of Internet traffic, including the mean arrival rate and the variance-to-mean ratio. The MMPP model 36 is a process with a set of underlying states that describe the traffic (e.g., high, medium, or low traffic), where each state corresponds to a Poisson process with a rate λᵢ, which allows the model to replicate the different time scales at which packets arrive. The MMPP is a conditional, observable, doubly-stochastic Poisson process whose intensity (i.e., underlying state) changes according to an underlying continuous-time Markov chain.

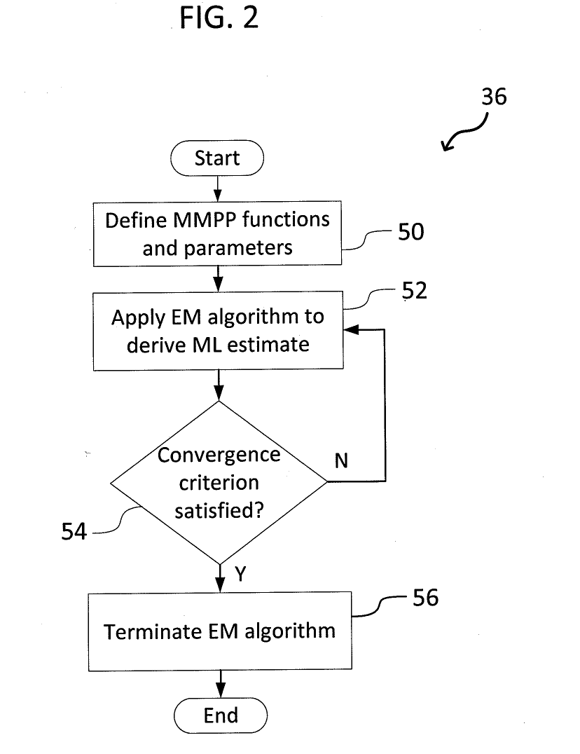

Referring to FIG. 2, shown are overall processing steps for processing traffic data using an MMPP model . Beginning in step 50, functions and parameters of the MMPP model are defined. Let {N(t),t>0} denote the observed conditional Poisson process and let {X(t),t≧0} denote the underlying continuous-time Markov chain with a state space {1, . . . ,r}. Let the r×r matrix Q denote the generator matrix of X(t). Let π denote a 1×r vector of initial state probabilities of X(t). Let the intensity of the conditional Poisson process at time t be given by λᵢ when X(t)=i. Let Δ be the r×r diagonal matrix with diagonal elements given by {λᵢ}.

Let Yⁿ={Y₁, . . . ,Yₙ} denote a sequence of n positive random variables representing network packet inter-arrival times, and let yⁿ={y₁, . . . yₙ} denote a realization of Yⁿ. Generally, the expressions considered involve the sequence Yⁿ={Y₁, . . . , Yₙ} of event inter-arrival times, so that N(t), the number of observed packets at time t, is given by N(t)=max{j|Σᵢ₌₀^{j}Yᵢ≦t} where Y₀=0. Let p(yⁿ; φ) denote an assumed parametric form of the probability density function (pdf) of Yⁿ, where φ is the parameter defined as φ={Q, Δ} as the role of π diminishes with time. Let “1” denote a r×1 vector of ones. The MMPP pdf, representing assumed network arrival times, is given by:

$$p ( {y}^{n} ; φ ) = π {\prod }_{t = 1}^{n} f ( {y}_{t} ; φ ) 1 \qquad Equation 2$$

where f(yₜ; φ) represents the MMPP transition density matrix:

f(yₜ; φ)=exp((Q−Δ)yₜ)Δ Equation 3

In step 52, a maximum likelihood (ML) MMPP parameter is estimated due to its desirable asymptotic properties and because Internet applications can involve very large amounts of data. To find an ML estimate, yⁿ are used as training signals:

$$\hat{φ} = {argmax}_{φ} p ( {y}^{n} ; φ ) \qquad Equation 4$$

There is no explicit form for the ML estimate, and instead a number of expectation maximization (EM) approaches have been derived to estimate the MMPP parameter, although in a preferred embodiment Rydén's MMPP EM algorithm using computational improvements is used.

Rydén's MMPP EM algorithm uses explicit expectation and maximization steps to fit MMPPs. The computational improvements comprise a scaling of the forward-backward procedure that does not require the use of custom floating-point software. Let φ={ Q, Δ} denote an existing parameter estimate. Rydén's algorithm defines 1×r vectors of forward densities {L(t) } and r×1 vectors of backward densities {R(t)} that are calculated recursively. When parameters are defined as L(0)=π and R(k+1)=1, the scaled recursions are given by:

$$\begin{matrix}Equations 5 and 6 & \\ L ( t ) = \frac{L ( t - 1 ) f ( {y}_{t} )}{{c}_{t}} & ( 5 ) \\ R ( t ) = \frac{f ( {y}_{t} ) R ( t + 1 )}{{c}_{t}} & ( 6 )\end{matrix}$$

Where the scaling factor is given by cₜ=L(t−1)f(yₜ)1, the log-likelihood of yⁿ can be readily calculated using:

$$log p ( {y}^{n} ; φ ) = {\sum }_{t = 1}^{n} log {c}_{t} \qquad Equation 7$$

Another computation improvement to Rydén's MMPP EM algorithm comprises the calculation of the integral of the exponential of an m×m matrix using the matrix exponential of a 2 m×2 m matrix. Thereby, given the forward and backward densities, the r×1 vector M (where ⊙ denotes element-wise multiplication) and the 2r×2r matrices {Cₜ} are calculated by:

$$\begin{matrix}Equations 8 and 9 & \\ M = {\sum }_{t = 1}^{n} {L ( t )}^{′} ⊙ R ( t + 1 ) & ( 8 ) \\ {C}_{t} = [ \begin{matrix}Q - Λ & Λ R ( t + 1 ) L ( t - 1 ) \\ 0 & Q - Λ\end{matrix} ] & ( 9 )\end{matrix}$$

Let [symbol] denote the upper-right r×r block of the matrix exponential e^{C}^{ₜ}^{y}^{ₜ} and m=Q⊙Σₜ₋₁ⁿ [symbol] ₜ/cₜ. The updated estimates φ={\hat{Q}, \dot{Δ}} are calculated using:

$$\begin{matrix}Equations 10 and 11 & \\ {\hat{λ}}_{i} = \frac{{q}_{ii} {M}_{i}}{{m}_{ii}} , & ( 10 ) \\ {\hat{q}}_{ij} = \frac{{q}_{ii} {m}_{ij}}{{m}_{ii}} , i \neq j & ( 11 )\end{matrix}$$

The diagonal elements of \hat{Q} are set so the rows of \hat{Q} sum to zero. Let {\hat{φ}^{k}}={(\hat{Q}^{k}, \hat{Δ}^{k})} denote a sequence of estimates resulting from the iteration of this procedure. The EM algorithm guarantees that p(yⁿ:\hat{φ}^{k})≧p(ŷⁿ;\hat{φ}^{k-1}).

In step 54, the convergence criterion, for ε>0 is defined as:

log p(yⁿ;\hat{φ}^{k})−log P(yⁿ; \hat{φ}^{k . . . 1})<nε Equation 12

If the convergence criterion is not satisfied, the EM algorithm reverts to step 52 for another iteration. If the convergence criterion is satisfied, the EM algorithm is terminated in step 56.

As discussed in FIG. 1 above, in step 16, a GLRT is used to classify traffic. Classification of the traffic as normal or anomalous involves a probability or likelihood which is assigned to each instance of new data under the statistical model. Where, φ₀ corresponds to the network not being under attack, the system chooses one of the following hypotheses as true:

H₀:yⁿ˜p(yⁿ;φ₀), (13)

H₁:yⁿ˜p(yⁿ;φ) where φ≠φₚ (14)

Equations 13 and 14

In statistical parlance, this is a classification problem for one simple and one composite hypothesis. A hypothesis is simple if the signal is described by a known pdf. A hypothesis is composite if the pdf of the signal is only known to be a member of a family of pdfs. If φ is assumed random with a known pdf, the composite hypothesis can be represented as a simple hypothesis using a Bayesian approach.

The network intrusion detection system treats network intrusion detection from packet arrival times as a binary hypothesis testing problem where H₀ denotes the hypothesis that the network is not under attack, and H₁ denotes the hypothesis that the network is under attack. Because the true pdfs of the arrival times under the two hypotheses are generally not known, a “plug-in” approach is used where a parametric form for the pdfs is assumed. The parameters estimated from training signals and the resulting pdfs are used in the likelihood ratio test as if they were the true pdfs. For network intrusion detection, although training signals for H₀ may be available, appropriate training signals for H₁ are generally difficult to obtain. New attacks are being continually developed and there is little evidence to suggest existing attack signals to be representative of future attacks. Indeed, hackers would appear to be motivated to develop new attacks that appear different than known attacks.

A GLRT is utilized to detect network intrusions because it does not require an explicit pdf for H₁. Instead, a parametric form for the pdf corresponding to H₁ is assumed and the parameter is estimated from the test signal. To apply the GLRT, the unknown parameter of the process under the composite hypothesis is estimated, in a maximum likelihood sense, from the test signal, and used as if it were the correct parameter. The GLRT test statistic is given by:

$$δ ( {y}^{n} ; {φ}_{0} ) = \frac{p ( {y}^{n} ; {φ}_{0} )}{{max}_{φ} p ( {y}^{n} ; φ )} \qquad Equation 15$$

Where η is a threshold, the decision is made according to:

$$\frac{1}{n} log δ ( {y}^{n} ; {φ}_{0} ) {{≶}^{{H}_{0}}}_{{H}_{i}} η \qquad Equation 16$$

The GLRT does not require knowledge of the parameter corresponding to H₁. It does, however, require an explicit φ₀ which may be estimated from training signals obtained when the network is not under attack.

There are two events useful for characterizing performance of the GLRT: a false alarm (e.g., choosing H₁ when H₀ is true), and a detection (e.g., choosing H₁ when H₁ is true). The loci of the probabilities of these events for various thresholds η is termed a receiver operator characteristic (ROC) curve, which is generally plotted with the relative frequencies of the events obtained from known test signals.

Asymptotic optimality of the GLRT in the Neyman-Pearson sense has been shown for independent identically distributed (iid) sources and Markov chain sources of any given order. The GLRT has been widely applied in many applications, although optimality thereof has not been shown for those applications, or for the processes of the present invention. However, optimality has been shown for an extension of the GLRT to model order estimation.

The present invention can be used in conjunction with, and complementary to, a variety of existing intrusion detection systems, methods, and models, such as host-based intrusion detection systems, network-based intrusion detection systems, signature-based methods, and statistical anomaly detection methods (e.g., self-similar models and Poisson models). The present invention could be used by itself, but the present invention can also be integrated into an existing system having complementary anomaly detection methods.

A host-based intrusion detection system (HIDS) can detect a variety of intrusions (e.g., key logging, spamming, botnet activity, spyware usage, etc.) by monitoring the dynamic behavior of a computer (e.g., which programs have access to specific resources), and the sequence of internal calls made by the host. A HIDS usually has a database of system objects to monitor and create checksums for each of these objects, where intrusions can be detected if the checksums do not match the objects in the database.

A network-based intrusion detection system (NIDS) scans all network packets at the router or host-level, and logs any suspicious packets (e.g., raising an alert if the system threat surpasses a threshold). Additionally, individual statistics about the packets can be tracked (e.g., which ports are being used, which TCP/IP layers are being used, etc.), and an alert raised if the difference between an instantaneous statistic and mean statistic surpasses a threshold. It is noted that the system disclosed herein could be integrated into both HIDS and NIDS systems for use therewith.

A signature-based method detects network intrusions by looking for a known sequence of events that puts a system at risk, i.e., a signature. This type of method is good at detecting known attacks and is an important aspect of intrusion detection as hacker scripts become more widely available on the Internet, allowing relatively unskilled attackers to perform these attacks. However, these systems are not as well prepared for detecting future attacks with unknown signatures.

Furthermore, a combination of statistical models could be combined by the present invention into a flexible, multi-tiered approach, where models may be added or removed as needed, which may be particularly applicable for networks that carry a large amount of traffic. In such an approach, classification could be made by aggregating the results of individual classifiers, which could speed up the classification process.

In an exemplary embodiment of a multi-tiered approach, the system includes the MMPP, the Exponential Mixture classifier, and the Poisson model (which is particularly advantageous due to its low computational requirement). In such an embodiment, the Poisson classifier could be used as a preliminary classifier. Then, if H₁ is chosen, the Exponential Mixture model is applied. Then, if the Exponential Mixture classification also chooses H₁, the MMPP classifier is used to confirm the classification. If H₀ is chosen by any of the individual classifiers, H₀ is classification result.

Performance of the MMPP was tested and compared to two other models (running Matlab on a machine with a 2.93 GHz Intel Xeon X7350 processor) using an intrusion detection evaluation dataset (the “DARPA dataset”) from J. W. Haines, et al., “1999 DARPA Intrusion detection evaluation: design and procedures,” MIT Lincoln Laboratory, Tech. Report 1062, Lexington, Mass., February 2001, the entire disclosure of which is expressly incorporated herein by reference. The DARPA dataset consists of five weeks of simulated network traffic, generated using statistics obtained from a real network located on a United States Air Force base. The portion of the database used corresponded to packets resulting from communications between external and internal computers.

Data from weeks 1-3 were used, where weeks 1 and 3 had no attacks and week 2 contained labeled “SYN” flood attacks. During SYN flood attacks, targeted computers were inundated with network packets requesting that the target establish a connection with a remote machine, which can potentially overwhelm the computer when such requests are left unresolved. In the dataset there were two SYN flood attacks, each approximately 206 seconds long. This data was segmented into 16 30-second intervals. From week 3 (no attacks), 12 3-minute intervals of bursty traffic was selected, for a total of 72 30-second intervals of attack free test data. These 88 30-second intervals each constitute a yⁿ.

Numerical experiments were conducted assuming three parametric forms for p(yⁿ; φ): an MMPP, a mixture of exponentials, and a Poisson process (i.e., an MMPP with r=1). Let yⁿ denote the training signal used to estimate φ₀ consisting of all week 1 packet inter-arrival times, with n=7293600.

The Poisson process is parameterized only by the intensity λ, thus φ=λ. The pdf is given by p(yⁿ;φ)=Πₜ₌₁ⁿλ exp(−λyₜ). Let \tilde{λ} denote the ML estimate of λ given by \tilde{λ}=n/Σₜ₌₁ⁿyₜ=18,418, which took about 0.05 seconds to estimate.

A Mixture of Exponentials has pdf:

$$p ( {y}_{t} ; φ ) = {\sum }_{i = 1}^{r} α ( i ) λ ( i ) {e}^{- λ ( i ) {y}_{t}} \qquad Equation 17$$

where {α(i)} are the mixture weights and {λ(i)} are the exponential rates. Thus φ={λ(1), . . . λ(r),α(1), . . . ,α(r)} is the parameter of the mixture model. An EM algorithm to estimate φ is given by:

$$\begin{matrix} Equations 18 and 19 & \\ {\hat{λ}}^{k + 1} ( i ) = \frac{{\sum }_{i} \text{?} ( i ; \text{?} )}{{\sum }_{t} {ξ}_{t} ( i ; {\hat{φ}}^{k} ) {y}_{t}} & ( 18 ) \\ {\hat{α}}^{k + 1} ( i ) = \frac{{\sum }_{i} {ξ}_{t} ( i ; \text{?} )}{n} \\ \text{?} \text{indicates text missing or illegible when filed} & ( 19 )\end{matrix}$$

Conditional probabilities ξₜ(i;\hat{φ}^{k}) were calculated, with r=4 and initial values \hat{α}⁰(i)=¼ for i=1, . . . 4 and \hat{λ}⁰=(1000, 100, 10.1)^{T}, using:

$${ξ}_{t} ( i ; {\hat{φ}}^{k} ) = \frac{{\hat{α}}^{k} ( i ) {\hat{λ}}^{k} ( i ) exp ( - {\hat{λ}}^{k} ( i ) {y}_{t} )}{p ( {y}_{t} ; {\hat{φ}}^{k} )} \qquad Equation 20$$

The algorithm was stopped using the convergence criterion of Equation 12 with ε=10⁻⁴. The algorithm converged after k=19 iterations, each taking approximately 6.4 seconds, with a final likelihood of p(yⁿ;\hat{φ}^{k})/n=3.406. The resulting estimates were:

$$\begin{matrix}Equations 21 and 22 & \\ {\hat{λ}}^{k} = ( \begin{matrix}1023.740 \\ 79.725 \\ 20.163 \\ 2.069\end{matrix} ) & ( 21 ) \\ {\hat{α}}^{k} = ( \begin{matrix}0.435 \\ 0.409 \\ 0.062 \\ 0.095\end{matrix} ) & ( 22 )\end{matrix}$$

The MMPP EM algorithm used r=4. The diagonal elements of the initial estimate \hat{Δ}⁰ were the final estimates of the Mixture of Exponentials given in Equations 21 and 22. Let A denote an r×r empirical transition matrix of the exponential mixture states, where the state during yₜ is that with largest conditional probability. The initial estimate \hat{Q}⁰ was calculated by:

\hat{Q}⁰=log(A) λ̅ Equation 23

If A has negative eigenvalues, Q̅⁰ will not be a valid generator matrix. To produce a valid generator matrix, elements of the rows of Q̅⁰ were scaled.

Using ε=10⁻⁴ in Equation 12, Rydén's EM algorithm converged in k=59 iterations, each taking approximately 42.7 minutes, with log p(yⁿ;\hat{φ}^{k})/n=3.457. The resulting estimates were:

$$\begin{matrix}{\hat{Λ}}^{k} = diag ( 556.587 , 39.232 , 0.030 , 0.828 ) & Equation 24 \\ {\hat{Q}}^{k} = ( \begin{matrix}- 298.766 & 23.529 & 275.238 & 1.94 \cdot {10}^{- 7} \\ 17.974 & - 40.709 & 7.447 & 15.282 \\ 98.148 & 53.904 & - 152.052 & 6.56 \cdot {10}^{- 6} \\ 1.286 & 0.127 & 0.159 & - 1.572\end{matrix} ) & Equation 25\end{matrix}$$

The GLRT was implemented using the calculated estimates of φ₀, where yⁿ was assumed to denote a sequence desired to classify as coming from H₁ or H₀. The denominator of Equation 15 was calculated using the ML estimate of φ where p(yⁿ; φ) is assumed to be a Poisson process, which simplified estimation considerably when compared to estimation when an MMPP is assumed (where n is generally too small to produce reliable MMPP estimates anyway). With this assumption, the GLRT test statistic from Equation 15 and 16 is given by:

$$log δ ( {y}^{n} ; {φ}_{0} ) = log p ( {y}^{n} ; {φ}_{0} ) - log {\prod }_{t = 1}^{n} \tilde{λ} {e}^{- \hat{λ} {y}_{t}} \qquad Equation 26$$

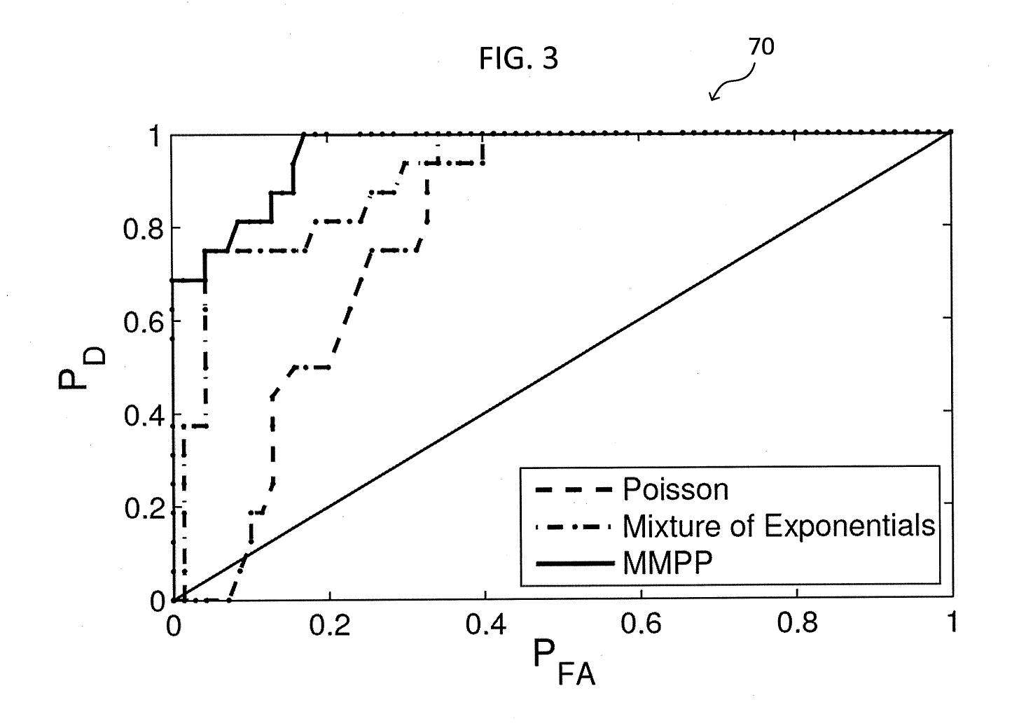

The resulting empirical ROC curves from the DARPA dataset are in chart 70 shown in FIG. 3, where P_{D} and P_{FA} represent the relative frequencies of detections and false alarms, respectively. The curve for the Poisson process, mixture of exponentials, and MMPP are shown as a dashed, dotted-dashed, and solid line, respectively. The MMPP classifier operated at speeds of approximately 50 times real time (i.e., the 30 second test signals were classified in just under one second). The mixture of exponential classifier operated at speeds approximately 2 orders of magnitude faster.

The performance of each model increased with model sophistication. The MMPP had the highest performance, suggesting that its assumption of Markovian rates is representative of real traffic. The Mixture of Exponential model is less elaborate, but requires less computation, and assumes both iid observations and a co-incidence between mixture switches and packet arrivals. The Poisson classifier is the simplest classifier, although computationally efficient, and assumes iid observations and a single traffic rate.

The MMPP detected 11 of 16 attack segments without producing a false alarm, whereas both of the other methods produced at least one false alarm before detecting any attack segments. At P_{D}=1, the MMPP produced only 12 of 72 possible false alarms. The Poisson model and Exponential Mixture classifier performed significantly worse than the MMPP and produced 28 and 24 false alarms, respectively.

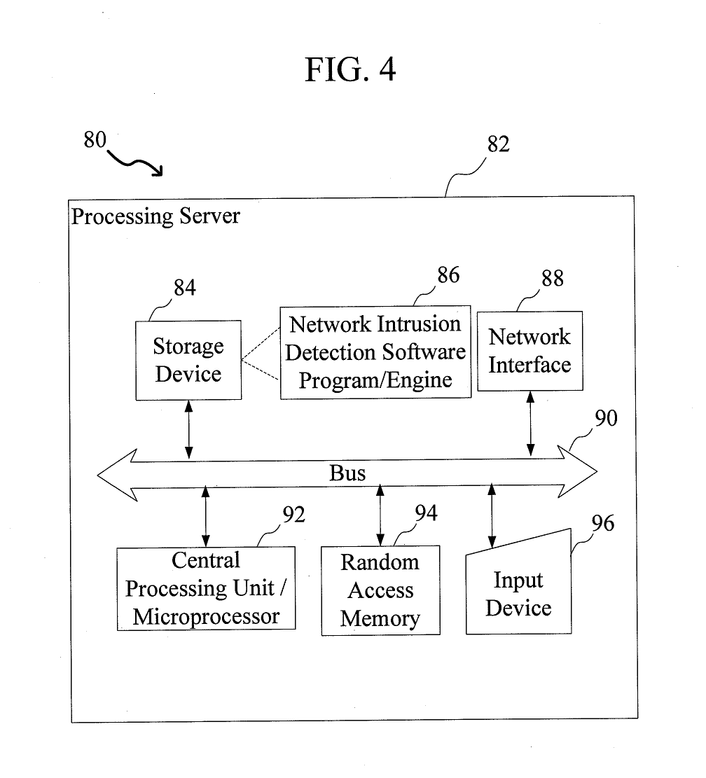

FIG. 4 is a diagram showing hardware and software components of the system 80 of the present invention capable of performing the processes discussed in FIGS. 1-3 above. The system 80 (computer) comprises a processing server 82 which could include a storage device 84, a network interface 88, a communications bus 90, a central processing unit (CPU) (microprocessor) 92, a random access memory (RAM) 94, and one or more input devices 96, such as a keyboard, mouse, etc. The server 82 could also include a display (e.g., liquid crystal display (LCD), cathode ray tube (CRT), etc.). The storage device 84 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 82 could be a networked computer system, a personal computer, a smart phone, etc.

The functionality provided by the present invention could be provided by a network intrusion detection software program or engine 86, which could be embodied as computer-readable program code stored on the storage device 84 and executed by the CPU 92 using any suitable, high or low level computing language, such as Java, C, C++, C#, .NET, MATLAB, etc. The network interface 88 could include an Ethernet network interface device, a wireless network interface device, or any other suitable device which permits the server 82 to communicate via the network. The CPU 92 could include any suitable single- or multiple-core microprocessor of any suitable architecture that is capable of implementing and running the detection program 86 (e.g., Intel processor). The random access memory 94 could include any suitable, high-speed, random access memory typical of most modern computers, such as dynamic RAM (DRAM), etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for detecting network intrusions comprising:
a computer system for electronically obtaining network traffic data;
a network intrusion detection engine executed by the computer system, the network intrusion engine executing:
one or more statistical models for processing and modeling the network traffic data to detect a pre-determined pattern in the network traffic data; and
a generalized likelihood ratio test algorithm applied to the modeled traffic data to determine whether the traffic data represents an attack,
wherein, if the data is classified as an attack, the detection engine indicates the attack to a user of the computer system.

2. The system of claim 1, wherein the computer system obtains the traffic data in real time.

3. The system of claim 1, wherein the computer system obtains the traffic data periodically.

4. The system of claim 1, wherein the one or more statistical models includes at least one of a self-similar model, a Poisson process model, a mixture of exponentials model, and a Markov modulated Poisson process model.

5. The system of claim 4, wherein the self-similar model is a fractional Brownian motion model or a Wavelet model.

6. The system of claim 1, wherein the one or more statistical models are combined into a multi-tiered model.

7. The system of claim 6, wherein the one or more statistical models comprise a Poisson process model used as a preliminary classifier, a mixture of exponentials model used as a secondary classifier, and a Markov modulated Poisson process model used as a tertiary classifier.

8. The system of claim 1, wherein the computer system and the network intrusion detection engine are integrated with a host-based intrusion detection system.

9. The system of claim 1, wherein the computer system and the network intrusion detection engine are integrated with a network-based intrusion detection system.

10. The system of claim 1, wherein the computer system and the network intrusion detection engine are utilized with a signature-based method.

11. A method for detecting network intrusions comprising:
electronically obtaining network traffic data at a computer system;
executing on the computer system a network intrusion detection engine, the network intrusion engine executing:
one or more statistical models for processing and modeling the network traffic data to detect a pre-determined pattern in the network traffic data; and
a generalized likelihood ratio test algorithm applied to the modeled traffic data to determine whether the traffic data represents an attack,
wherein, if the data is classified as an attack, the detection engine indicates the attack to a user of the computer system.

12. The method of claim 11, wherein the computer system obtains the traffic data in real time.

13. The method of claim 11, wherein the computer system obtains the traffic data periodically.

14. The method of claim 11, wherein the one or more statistical models includes at least one of a self-similar model, a Poisson process model, a mixture of exponentials model, and a Markov modulated Poisson process model.

15. The method of claim 14, wherein the self-similar model is a fractional Brownian motion model or a Wavelet model.

16. The method of claim 11, wherein the one or more statistical models are combined into a multi-tiered model.

17. The method of claim 16, wherein the one or more statistical models comprise a Poisson process model used as a preliminary classifier, a mixture of exponentials model used as a secondary classifier, and a Markov modulated Poisson process model used as a tertiary classifier.

18. The method of claim 11, wherein the computer system and the network intrusion detection engine are integrated with a host-based intrusion detection system.

19. The method of claim 11, wherein the computer system and the network intrusion detection engine are utilized with a network-based intrusion detection system.

20. The method of claim 11, wherein the computer system and the network intrusion detection engine are integrated with a signature-based method.

21. A computer-readable medium having computer-readable instructions stored thereon which, when executed by a computer system, cause the computer system to perform the steps of:
electronically obtaining network traffic data at a computer system;
executing on the computer system a network intrusion detection engine, the network intrusion engine executing:
one or more statistical models for processing and modeling the network traffic data to detect a pre-determined pattern in the network traffic data; and
a generalized likelihood ratio test algorithm applied to the modeled traffic data to determine whether the traffic data represents an attack,
wherein, if the data is classified as an attack, the detection engine indicates the attack to a user of the computer system.

22. The computer-readable medium of claim 21, wherein the computer system obtains the traffic data in real time.

23. The computer-readable medium of claim 21, wherein the computer system obtains the traffic data periodically.

24. The computer-readable medium of claim 21, wherein the one or more statistical models includes at least one of a self-similar model, a Poisson process model, a mixture of exponentials model, and a Markov modulated Poisson process model.

25. The computer-readable medium of claim 24, wherein the self-similar model is a fractional Brownian motion model or a Wavelet model.

26. The computer-readable medium of claim 21, wherein the one or more statistical models are combined into a multi-tiered model.

27. The computer-readable medium of claim 26, wherein the one or more statistical models comprise a Poisson process model used as a preliminary classifier, a mixture of exponentials model used as a secondary classifier, and a Markov modulated Poisson process model used as a tertiary classifier.

28. The computer-readable medium of claim 21, wherein the computer system and the network intrusion detection engine are integrated with a host-based intrusion detection system.

29. The computer-readable medium of claim 21, wherein the computer system and the network intrusion detection engine are integrated with a network-based intrusion detection system.

30. The computer-readable medium of claim 21, wherein the computer system and the network intrusion detection engine are utilized with a signature-based method.
